(19) United States
(12) Patent Application Publication
(10) Pub. No.: US 2006/0237858 A1
(43) Pub. Date: Oct. 26, 2006

(54) Second venturi insert providing air/fuel mixture velocity enhancement

(76) Inventor: Lonn M. Peterson, Richmond, MN (US)

Correspondence Address: David George Johnson, Post Office Box 286, Aitkin, MN, 56431, US

(21) Appl. No.: 11/112,465

(22) Filed: Apr. 21, 2005

(51) Int. Cl. F02M 19/10

(52) U.S. Cl. 261/51; 261/DIG. 12; 261/DIG. 55; 261/DIG. 56

(57) ABSTRACT

A carburetor (1) having an existing venturi upstream of a throttle plate (7) and a bore (17) downstream of a throttle plate (7) is provided with a second venturi (14) which increases airflow velocity and promotes fuel atomization. An aerodynamic piece or wing (15) is mounted to the top of the venturi to further define the airflow path and to prevent the downstream fuel/air mixture (10) from losing velocity after passing the throttle plate. The wing (15) includes a first set of tabs (41, 42) to secure the wing to the engine intake manifold and as second set of tabs (43, 44) to secure the combined wing (15) and venturi to an oversized carburetor bore. A cutout (21) in the venturi (14) prevents interference with the carburetor fuel jet (5). The wing (15) may be formed with a specially shaped trailing edge (51) in order to accommodate the contours of the throttle plate.

### FIELD OF THE INVENTION

The present invention relates generally to the field of carburetion, and more particularly to the field of carburetor venturi structures and accessories.

### DESCRIPTION OF RELATED TECHNOLOGY

A carburetor is a device for mixing air and fuel in an internal combustion engine in order to provide a combustible fluid for introduction into a cylinder or other combustion chamber. The carburetor typically has a central bore that is obstructed by a throttle plate which, depending upon the position of the throttle plate admits relatively more or less of the fuel/air mixture into the subsequent or downstream venturi portion of the carburetor. For relatively higher powered engines, the carburetor bore is relatively larger in diameter because a relatively greater amount of fuel and air is needed to support the combustion process that generates the higher power. However, at relatively lower throttle settings, a large bore carburetor becomes relatively inefficient because the smaller volume of the fuel/air mixture occupies the entire large bore volume, thereby reducing both turbulence and mixture velocity and promoting poor mixing of the fuel and air.

A typical engine operates over a wide range of power levels, ranging from the low end associated with idling to the midrange and high end associated with rapid acceleration. Since the air/fuel mixture supplied to the engine is typically provided by a single carburetor, selecting a carburetor having the correct bore size is very important in determining overall engine performance. A relatively smaller carburetor delivers quick and stable power at the low end while lacking sufficient fuel/air delivery at the midrange and top end due to the limited flow capability of the smaller bore. A larger carburetor delivers the desired power from the midrange to the top end while lacking stability, responsiveness and fuel efficiency at the low end due to the relatively slower air speeds associated with lower throttle settings.

Since the vast majority of engines operate with a single carburetor having a fixed bore, most engines have to some degree a poor throttle response otherwise known as throttle lag. This is a commonly encountered problem with many types of sporting vehicles such as motorcycles, all terrain vehicles, scooters, go carts and personal watercraft. The very nature of the vehicle design encourages aggressive driving and sometimes racing.

The type of carburetor typically used in a recreational vehicle uses a flat, sliding plate as the throttling mechanism. An example of such a carburetor is disclosed in U.S. Pat. No. 4,814,115, entitled SLIDE AND PIN TYPE CARBURETOR, issued on Mar. 21, 1989 to Hashimoto et al. A problem often associated with flat slide type carburetors is called fuel puddling or streaking which occurs when liquid fuel exits the pilot jet, flows along the carburetor body and into the engine while remaining in a liquid state. This is a result of insufficient air velocity within the carburetor bore that is needed to promote atomization of the fuel into airborne droplets. After a sufficient quantity of fuel has collected, some of it may (or may not) vaporize at random intervals causing an excessive amount of fuel to be instantaneously sent to the combustion chamber.

Another frequently encountered problem is an erratic idle response that causes the engine speed to fluctuate higher and then lower, or to maintain an engine speed that is higher than an acceptable idle speed even though the throttle has been fully returned to its lowest idle position. Large bore single and twin cylinder two cycle engines are often subject to the erratic idle syndrome. Various theories have been proposed to explain the erratic idle phenomenon. One recent article (SnowTech Magazine, October/November 2003, page 8) attributed idling problem to “ . . . air leaking around the flat slides themselves, and this inconsistency is very likely the cause of the occasional high idle speeds . . . We can compensate for it by adding more fuel to offset the extra air leaking around the flat slides”. A subsequent article (SnowTech Magazine, December 2003, page 13) further stated that carburetors are typically calibrated to be “ . . . as lean as possible for improved fuel economy, and the matter of high idle is little more than a lean condition that is easily remedied by adding more fuel to the low speed circuits . . . [Y]ou have to . . . utilize the pilot air jet, pilot fuel jet and fuel screw to get the right calibration balance . . . You need to be willing to sacrifice 2-3 mpg . . . to get rid of the high idle inconsistencies”. Yet another article (SnowTech Magazine, January/February 2004, page 62) states that discontinuities in idling speed are “being caused by a resonance phenomenon”.

The inventor of the present invention has discovered that in fact the inconsistent idling problem is due to large bursts of air being introduced into the engine followed by bursts of heavy wet fuel that is poorly atomized. The lack of atomization is due to the relatively low air speeds at partial throttle. The flow of the air/fuel mixture at low throttle settings can be better understood with reference to FIG. 1. The carburetor 1 includes a body 9 and a main intake passageway formed as a venturi 2 with the arrow 3 indicating the direction of flow of the suction air 4. A pilot jet circuit 5 extends upwardly from the float chamber 6 in which fuel resides. The pilot jet circuit 5 introduces fuel into the suction air 4, the amount of suction air being controlled by the size of the pilot jet which constitutes the idling or low speed fuel system. Precise control of fuel flow is regulated by a jet needle 65 that is progressively surrounded by the sleeve 64, and which regulates engine fuel demand from engine start until a throttle opening of about 75 percent is achieved. Nut 8 is shown securing the float chamber to the carburetor body 9. The throttle plate 7 is shown at a relatively low, half throttle setting, that is, the cross section of the intake passageway is obstructed by approximately fifty percent, which does not correspond to half power but rather to a power setting that is substantially less than half of full available power. At this low power setting, the fuel/air mixture 10 expands into the increased downstream upper bore volume 11 and suffers a substantial loss in velocity, producing eddy currents 12, for example, and a reduction in the desired atomization of the fuel.

Numerous efforts have been made to maintain downstream air/fuel mixture velocity. One method is to manufacture an asymmetrical carburetor bore, reducing the cross section of the bore near the bottom and enlarging the cross section near the top, creating an oval cross sectional shape. Another type of device is disclosed in U.S. Pat. No. 4,474,145, entitled FUEL SUPPLY SYSTEM FOR INTERNAL COMBUSTION ENGINE, issued on Oct. 2, 1984 to Boyesen. The Boyesen device is a solid, teardrop shaped obstruction with a decreasing cross section in a downstream direction. While the Boyesen device accomplishes the goal of reducing fluctuations in the velocity of the fuel/air mixture, the device occupies a substantial amount of cross sectional area within the air flow passageway, leading inevitably to absolute velocity losses induced by its presence. Neither of the foregoing schemes is amenable to modifying an existing carburetor in the field due to their relative complexity and need for specialized tooling.

The need exists for a carburetor enhancement that maintains higher air flow velocities within the carburetor bore at initial and low speed throttle settings. A higher air speed results in a more thorough atomization of the fuel. The better the fuel is atomized, the more forgiving the carburetor/engine combination will be to variations in either ambient temperature or altitude for a carburetor of a given size.

### SUMMARY OF THE INVENTION

The ideal carburetor for all throttle settings would be a relatively large bore carburetor that can be made to behave as a smaller bore carburetor at lower throttle settings. The present invention addresses this goal by providing a simple, cost effective device that can be readily installed in the field without any modification to the existing carburetor. The present invention is a carburetor insert located on the downstream (or engine) side of a carburetor. The carburetor insert includes two discrete pieces, the first of which is a wing like airfoil structure that divides the carburetor bore approximately in half along a horizontal plane.

The airfoil extends downstream beginning at a region closely adjacent to the flat slide throttle plate to a region slightly beyond the end of the carburetor bore. The wing or airfoil includes two oppositely oriented tabs that extend beyond the carburetor bore and which terminate adjacent to the outside of the carburetor body casting. The two tabs serve the purpose of securing or locking the airfoil in place within the carburetor bore. The wing can be altered as required to accommodate one or more oil injection nozzles. A second component of the insert is a ramp like structure. The ramp component is located on the downstream engine side of the carburetor, occupying the bottom half of the carburetor bore. The ramp occupies a region that is in close proximity to the carburetor flat slide, forming an inclined plane or ramp that tapers so as to decrease the available cross sectional area of the lower half of the carburetor bore as the bore extends toward the engine. The ramp like structure terminates at the end of the carburetor bore. Various shapes and dimensions of the ramp may be used to achieve desired airflow values for a given throttle setting. The ramp includes at least two carrier grooves adapted to accept and support the wing component. When joined, the wing and the ramp components together form a second venturi within the carburetor bore, the first venturi being the original upstream venturi present in any carburetor The second venturi created by the present invention is located in the lower half of the carburetor bore and is downstream of the existing standard venturi. The presence of the ramp does not inhibit the normal function of the pilot jet circuit and the choke circuit.

The wing component tends to restrict the air flow to the bottom half of the carburetor bore by preventing the air flow from drifting or looping upwardly toward the top of the carburetor bore when the throttle is only partially open. The ramp component acts as a second venturi which further accelerates the air. The higher velocity of the airflow addresses a number of issues. The throttle response is more nearly instantaneous due to the higher air velocity present at partial throttle settings. This characteristic is valuable in a sport vehicle as the rider is able to accelerate more rapidly as a result of a relatively greater rate of engine power increase as the throttle is opened. The absolute value of the peak engine power produced during the first half of the throttle plate travel is also increased.

The vehicle operator is able to momentarily elevate the front of the vehicle solely by manipulation of the throttle, as may be required, for example, in order to negotiate bumps, inclines, gaps or rough areas. The rider is also able to steer in reliance on the improved throttle response. Engine temperature stabilize relatively more quickly due to the improved fuel atomization resulting from the higher airflow velocity. The improved fuel atomization also contributes to more thorough fuel combustion, resulting in a decrease in harmful emissions.

The present invention addresses the erratic idling problem by properly atomizing the relatively dense, moist fuel with a high velocity air column. Fuel is forced along the ramp by the high velocity air column. The fuel is then forced off of the end of the ramp, becoming airborne and quickly atomizing. The effect of the ramp is to substantially reduce the capillary action of flowing, liquid fuel which can produce streaking and puddling. Since the airflow is prevented from flowing upwardly after passing the carburetor slide, the fuel/air mixture tends to flow along a relatively straight path at a relatively higher rate of speed. The second venturi formed by the ramp tends to further increase the air flow velocity.

### BRIEF DESCRIPTION OF THE DRAWINGS

FIG. 1 is a schematic view of a prior art carburetor throttle assembly;

FIG. 2 is a perspective view of a carburetor insert constructed according to the principles of the present invention;

FIG. 3 is a perspective view of a the carburetor insert depicted in FIG. 2 shown in an installed position within a carburetor bore;

FIG. 4 is a front elevation of the venturi portion of the carburetor insert depicted in FIG. 2;

FIG. 5 is a rear elevation of the venturi portion of the carburetor insert depicted in FIG. 2;

FIG. 6 is a side elevation of the venturi portion of the carburetor insert depicted in FIG. 2;

FIG. 7 is a plan view of the venturi portion of the carburetor insert depicted in FIG. 2;

FIG. 8 is a side elevation of the airfoil portion of the carburetor insert depicted in FIG. 2;

FIG. 9 is a front elevation of the airfoil portion of the carburetor insert depicted in FIG. 2;

FIG. 10 is a side elevation of a second embodiment of an airfoil constructed according to the principles of the present invention;

FIG. 11 is a front elevation of the second embodiment of the airfoil depicted in FIG. 10;

FIG. 12 is a top plan view of the second embodiment of the airfoil depicted in FIG. 10;

FIG. 13 is a front elevation of a third embodiment of an airfoil constructed according to the principles of the present invention;

FIG. 14 is a schematic representation of carburetor airflow resulting from the installation of the carburetor insert depicted in FIG. 2; and

FIG. 15 is a graph depicting carburetor performance with and without the presence of the carburetor insert depicted in FIG. 2.

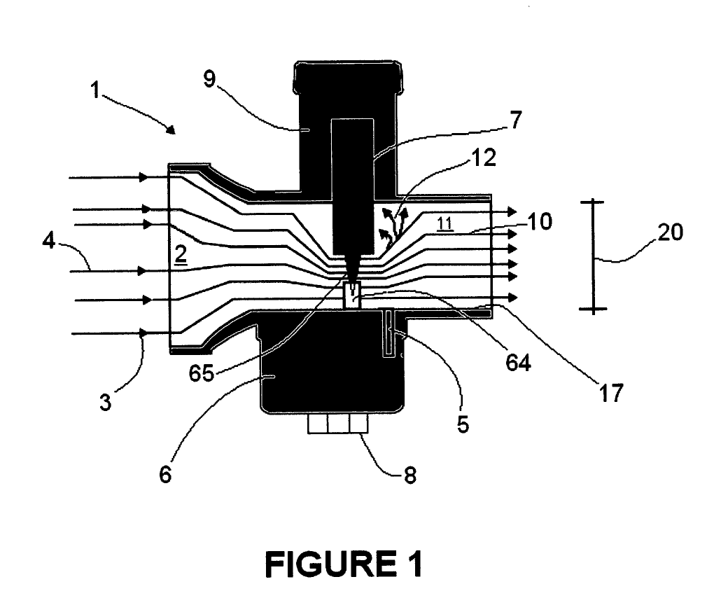

### DETAILED DESCRIPTION OF THE INVENTION

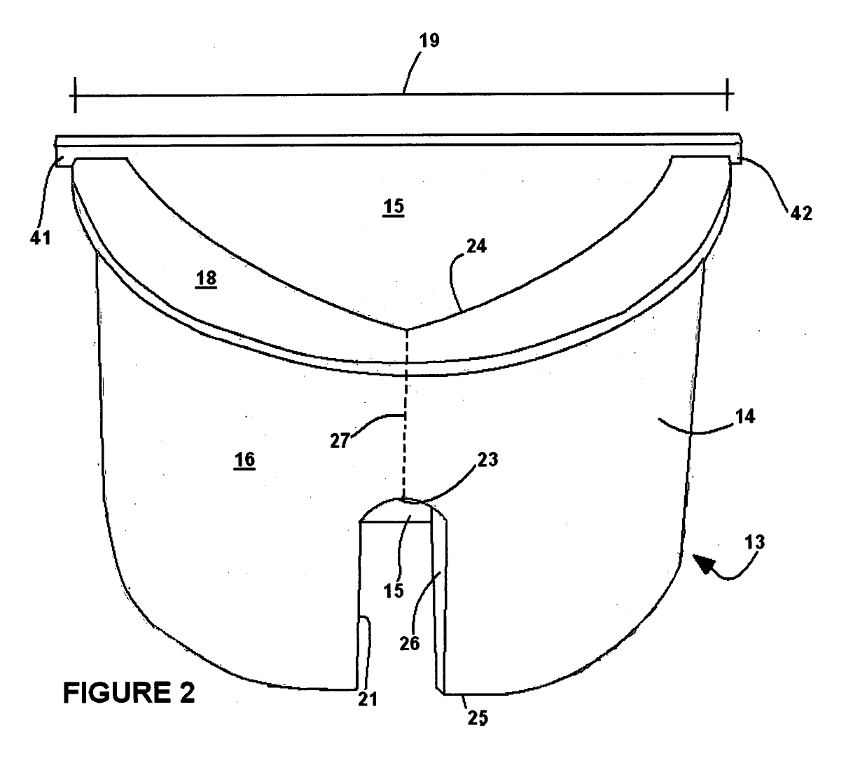

Referring generally to FIG. 2, the carburetor insert 13 of the present invention is seen to include a venturi component 14 and an airfoil or wing component 15. The venturi 14 is formed to have an outer wall 16 shaped generally as a semicircular cylinder that is dimensioned to fit snugly within the cylindrical bore 17 of a carburetor 1. The venturi 14 includes a lip 18 that has an outer diameter 19 somewhat greater than the inner diameter 20 of bore 17. The venturi 14 is intended to be inserted into the bore 17 and the lip 18 provides a positive mechanism for preventing insertion beyond the desired point. Further, the venturi 14 includes a cutout or void region 21 which is intended to provide clearance for the carburetor pilot fuel jet 5. If the venturi 14 were to be inserted too far into the bore 17, the edge 23 of the cutout 21 might collide with and damage the fuel jet 5.

The venturi 14 may be composed of any rigid, fuel resistant material such as metal or plastic. Alternatively, the venturi 14 may be formed within the bore 17 at the time of carburetor manufacture and so may be secured by means other than the lip 18, or the venturi 14 may be integrally formed or machined as the inherent shape of the bore 17 and be composed of the same material as the bore 17.

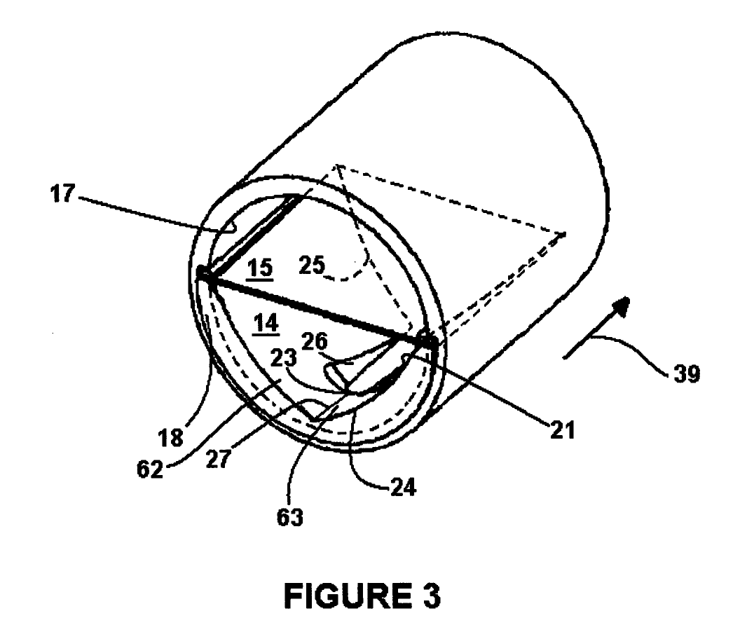

The venturi 14 may also be manufactured and assembled from multiple discrete pieces. Referring also to FIGS. 3 and 6, the venturi 14 is seen to taper or decrease in thickness longitudinally as the inner venturi wall 24 progresses from the leading or engine side edge 24 toward the trailing or throttle side edge 25 within the bore 17. The taper is also evident by inspection of the varying thickness of the wall 26 of cutout 21. The angle of the taper is in the range of one half of a degree to as great as twenty degrees, and the taper itself can be formed as a flat slope, a series of steps or take the shape of a continuous French curve. The region of the venturi between the engine side edge 24 and the top edge 23 of the cutout 21 forms a crease 27. The sidewalls 62 and 63 abut the crease at an angle of between 180 degrees and 90 degrees. To the extent that excess fuel may flow from the pilot jet circuit 5, the fuel will tend to be entrained by the crease 27 and flow along the venturi sidewalls 62 and 63 until being forced off of the engine side edge 24 of the ramp and then atomized in the higher velocity airflow present within the venturi 14.

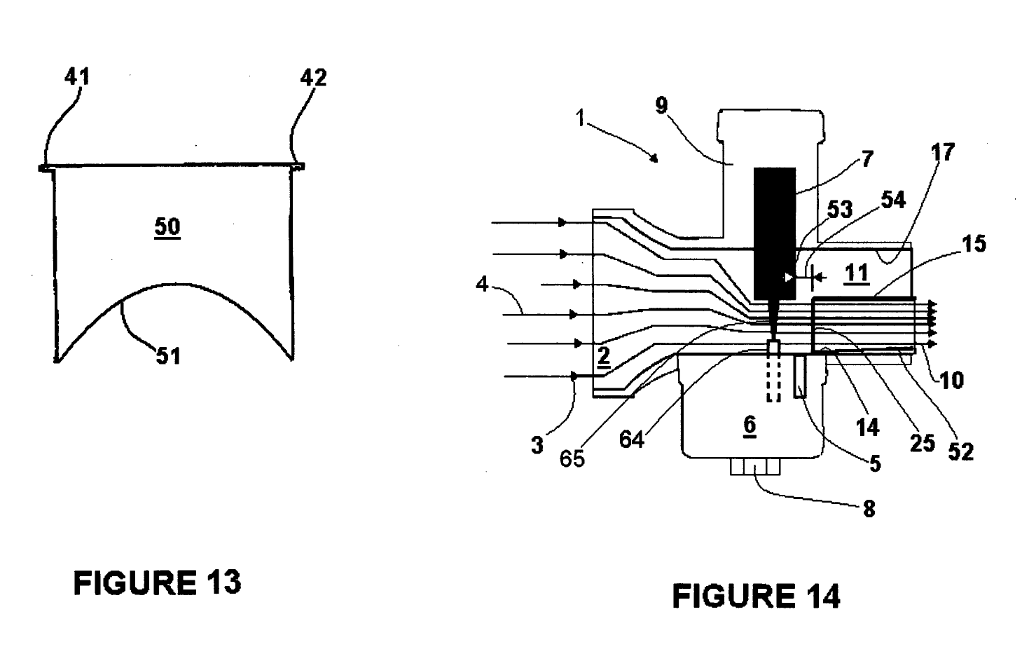

Referring also to FIGS. 8 and 9, the wing or airfoil component 15 can be seen in greater detail. The wing 15 may be composed of any rigid, fuel resistant material such as a plastic or metal. The height 28 of the wing 15 is, in one preferred embodiment, approximately 1.25 inches, but may be made longer or shorter depending on the length of the venturi 14. While the wing 15 may be nominally of a length 35 which is the same as the length 29 of the venturi 14, as seen in FIG. 5, the wing 15 may be longer or shorter depending on such factors as the geometry of the throttle plate 7, the characteristics of the carburetor bore 17 or the desired aerodynamic qualities downstream of the throttle plate 7. While in the preferred embodiment the wing is substantially planar, the wing 15 may also be curved or perforated. Multiple wings may also be arranged in a stacked or spaced apart relationship, with a top wing serving as a lid over the venturi while an additional wing resides below and within the cross section of the venturi 14. An additional wing may also be placed within the upper region 11 of the carburetor bore 17 to define the path of airflow that may have spilled over the wing 15. In some circumstances the wing 15 may be omitted entirely while still obtaining desirable fuel/air mixture atomization with the venturi 14 alone. As best seen in FIG. 13, an alternative wing 50 may be formed to accommodate differing throttle shapes. One common throttle configuration is the round slide, and the wing 50 is formed to include an edge 51 which will permit the wing to maintain a constant, spaced apart relationship with a round slide throttle plate.

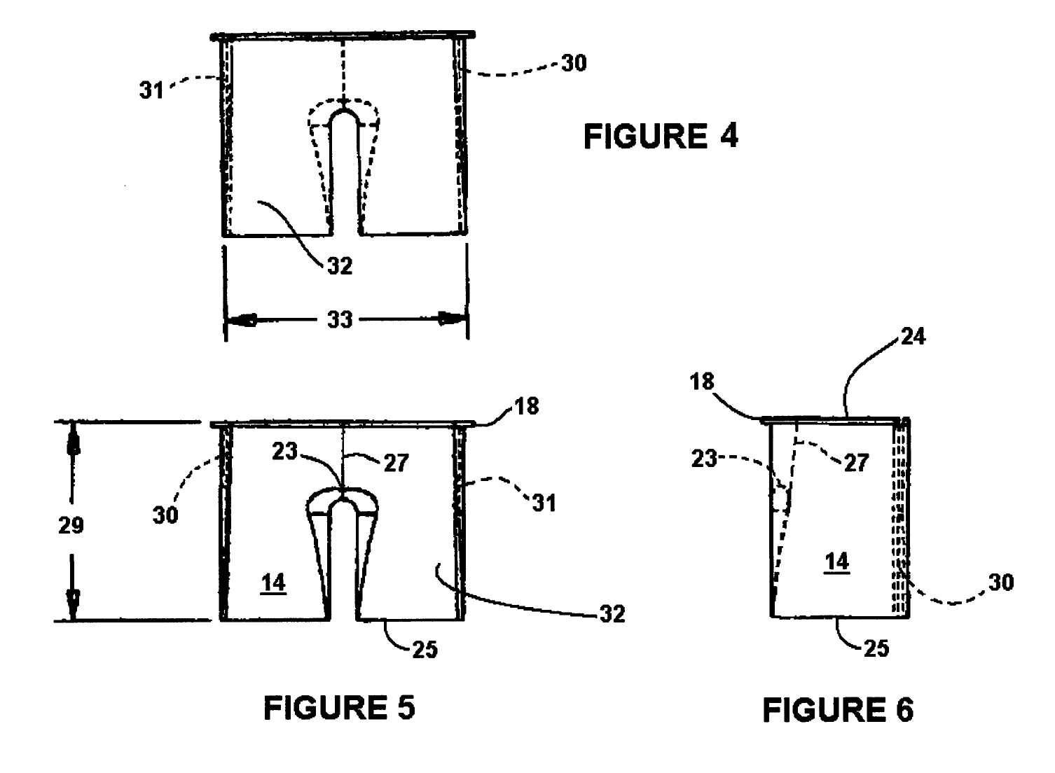

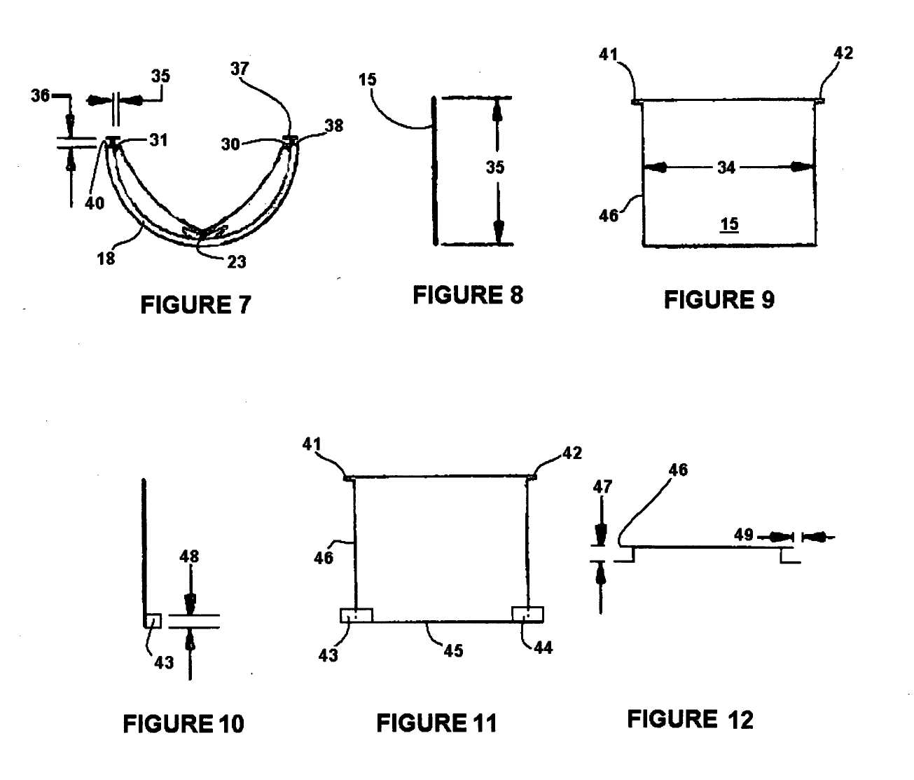

As best seen in FIGS. 6 and 7, the wing 15 is secured to the venturi 14 by means of grooves 30 and 31 formed within the venturi sidewall 32. In one embodiment illustrated in FIG. 4, the diameter 33 of the venturi 15 is approximately 1.5719 inches. The width 34 of the wing is approximately 1.5037 inches, resulting in a desired groove depth 35 of approximately 0.065 inch. The grooves 30 and 31 may be formed by scoring the sidewall 32. An additional, outer set of grooves 38 and 40 may also be formed on the outer surface of the venturi 15 in order to accommodate a mating fitting or rail within the carburetor bore 17. Alternatively, a post 37 containing the grooves 30, 31, 38 and 40 may be affixed to the venturi 14 by welding or by an adhesive.

The post 37 has a height 36 of approximately 0.080 inch. The wing 15 is inserted into the grooves 30 and 31 by means of a sliding motion in the direction of arrow 39. The tabs 41 and 42 serve as stops which prevent the wing 15 from sliding completely beyond the venturi lip 18. Further, the tabs 41 and 42 tend to impale or otherwise engage any gasket material or rubber manifold linked to the carburetor, further securing the wing 15 so as not to vibrate or shift in position.

Referring also to FIGS. 10, 11 and 12, an alternative or additional method of securing the wing 15 and venturi 14 within the carburetor bore 17 is disclosed. In some situations, the inner diameter of the bore 17 may be so much larger than the outer diameter 33 of venturi 14 that the venturi 14 is not held firmly in place. In those situations, resilient tabs 43 and 44 may be formed adjacent to the trailing edge 45 of wing 15. The actual dimensions of the tabs 43 and 44 may vary depending on the range of carburetor bores 17 expected to be encountered. Typical dimensions for tabs 43 and 44 are a height 47 of approximately 0.1 inch, a length 48 of approximately 0.1 inch, and an extension distance 49 beyond the edge 46 of the wing 15 of approximately 0.07 inch.

Referring also to FIG. 14, the installation and function of the present invention may be better understood. The venturi 14 and wing 15 are installed in the carburetor bore 17 downstream of the throttle plate 7. The trailing edge 25 is inserted into the bore 17 until it approaches the leading edge 53 of the throttle plate 7. The venturi 14 is typically manufactured such that the outer diameter of the venturi creates an interference fit with the surface of the carburetor bore 17 as the venturi is slidably inserted into the bore. When the use of an interference fit is not possible, the venturi 14 may be glued in place within the bore 17 or held in place by means of suitable fasteners.

Upon insertion of the venturi 14 into the carburetor bore 17, the actual distance 54 between the trailing edge 25 and the leading edge 53 is somewhat critical, and must reside within the range of 0.025 inch and 0.75 inch. In most installations the distance 54 is optimized in the range of approximately 0.100 inch or less. A spacing 54 of greater than 0.5 inch typically results in an excessive amount of the fuel/air mixture 4 failing to enter the venturi 15, while a spacing of closer than 0.025 inch increases the opportunity for debris or vibration to cause venturi 15 to foul or impede the movement of the throttle plate 7. All of the fuel/air mixture 10 is seen to pass through the venturi 14 and along the inclined venturi surface 52. Substantially none of the fuel/air mixture 10 is permitted to flow into the upper bore region 11 due to the presence of the wing 15.

Although the second venturi 14 is shown entirely beneath the upper bore region 11, in practice the second venturi 14 may assume several configurations. In particular, the venturi 14 does not necessarily need to occupy approximately 180 degrees of the circumference of the carburetor bore 17 as illustrated, but rather may extend for less than sixty degrees, resulting in a venturi 14 that occupies only a relatively small amount of the bore cross section. Further, the venturi 14 does not necessarily need to occupy the lowermost portion of the carburetor bore 17, but rather may be positioned along the sides of the bore. Stated differently, the plane defined by the wing 15 may be substantially horizontal as illustrated, but the combination of the wing 15 and venturi 14 may be inserted into the carburetor bore 17 such that the plane of the wing 15 is vertical or any angle between horizontal and vertical. Further, some carburetors may be constructed in such a manner that the carburetor bore 17 ends substantially at the leading edge 53 of the throttle plate 7. In such cases, the combination of the wing 15 and venturi 14 may be affixed so as to be external to, and an extension of, the carburetor bore 17.

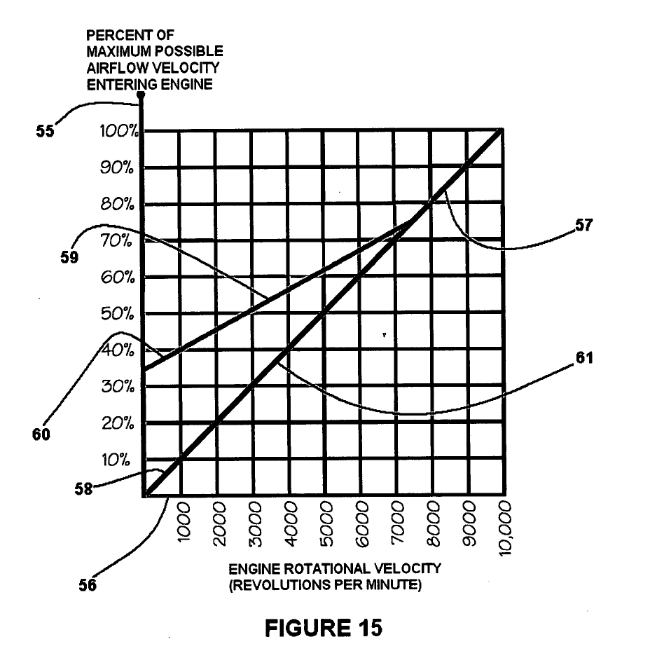

The effects of adding the combined wing 15/venturi 14 to a carburetor 1 are illustrated in FIG. 15. The vertical axis 55 signifies the percentage of the maximum possible airflow entering an engine intake manifold downstream of the carburetor 1. The horizontal axis 56 indicates the rotational speed of a representative engine, such as might be found on a snowmobile or all terrain vehicles. The curve 57 represents the airflow produced by a prior art carburetor 1 having only the single venturi inherent in standard carburetor construction. As seen at point 58, for example, the airflow velocity is approximately seven percent of the maximum possible airflow at a typical idle setting of approximately 500 revolutions per minute. This corresponds to an airflow velocity that produces relatively poor fuel atomization and the resultant erratic engine idling.

The curve 59 represents the airflow produced by the same carburetor 1 with the installation of the combined venturi 14 and wing 15. At the idle setting of approximately 500 revolutions per minute, point 60 indicates that the airflow velocity is approximately thirty eight percent of the maximum available, resulting in excellent fuel atomization and a steady engine idle. Note that the thirty eight percent of maximum airflow figure is not achieved on curve 57 until point 61, which corresponds to a engine speed of approximately 3700 rpm, which is a typical operational speed achieved during normal cruise operation of the vehicle. In this manner the present invention achieves the steady state engine operating conditions normally associated with engine cruise power settings while the engine is operating in the low power and idling regimes.

I claim:

1. A carburetor, comprising:
a bore through which air and fuel may pass en route to a combustion chamber;
a first venturi residing within the bore and being adapted to guide air entering the carburetor; and
a second venturi residing within the bore at a location relatively downstream from the first venturi.

2. The carburetor of claim 1, further comprising:
a throttle plate, the throttle being adapted to obstruct varying portions of a cross section of the bore, thereby regulating an amount of air flowing through the bore; and
a fuel control device, the fuel control device being adapted to introduce fuel into the air flowing through the carburetor bore, the second venturi being located downstream of at least one of the following: (a) the throttle plate, and (b) the fuel control device.

3. The carburetor of claim 2, wherein the bore is formed to include an upper region and a lower region, the second venturi being located in at least one of the following: (a) the lower region, and (b) the upper region.

4. The carburetor of claim 3, wherein the second venturi is formed of a fuel resistant material, the venturi being formed as at least one of the following: (a) an assembly composed of multiple discrete components, (b) a single, integrally formed component, (c) a die cast component, and (d) a machined component.

5. The carburetor of claim 4, wherein the second venturi is formed as a discrete insert, the insert being slidably placed within the bore.

6. The carburetor of claim 5, wherein the carburetor further comprises a body, the second venturi being formed as at least one of the following: (a) a cast component, and (b) a machined component, wherein each component is an integral portion of the body.

7. The carburetor of claim 6, wherein the second venturi further comprises:
a longitudinal crease, the crease serving to divide the second venturi into two substantially identical halves wherein each half terminates at an upper edge; and
an adjustable aerodynamic component being affixed to the second venturi at each upper edge so as to span the second venturi.

8. The carburetor of claim 7, wherein the second venturi further comprises a bottom surface extending outwardly from the longitudinal crease, the bottom surface extending upwardly in a downstream direction so as to increase airflow velocity through the second venturi.

9. The carburetor of claim 8, wherein the bottom surface of the second venturi extends laterally toward each upper edge so as to form sidewalls abutting at the crease at an angle of between 180 degrees and 90 degrees, thereby causing the airflow to occupy a central region of the bore.

10. The carburetor of claim 9, wherein the second venturi abuts at least a portion of an inner surface of the bore.

11. An venturi insert adapted to be slidably mounted within a carburetor bore, comprising:
a curved body adapted to abut a sidewall of the carburetor bore;
an inclined inner surface tapering toward a longitudinal axis of the carburetor bore as the inner surface progresses in a direction parallel to airflow within the carburetor bore;
a lip, the lip being formed along a perimeter of the venturi insert so as to prevent insertion of the venturi insert into the carburetor bore beyond a desired distance; and
a void region to accommodate fuel delivery and regulation components protruding into the carburetor bore.

12. The venturi insert of claim 11, wherein the lip causes the venture insert to reside within the carburetor bore at a location downstream of the fuel delivery and regulation components which protrude into the carburetor bore.

13. The venturi insert of claim 12, further comprising an aerodynamic piece, the aerodynamic piece comprising:
a continuous surface adapted to mate with a portion of the curved body; and
at least one tab extending from the continuous surface adapted to maintain a location of the aerodynamic piece with respect to a component external to the carburetor bore.

14. The venturi insert of claim 13, wherein the aerodynamic piece further comprises:
an upstream leading edge; and
a downstream trailing edge, the upstream leading edge being positioned at a location within the range of 0.025 and 0.500 inch from a carburetor throttle plate residing within the carburetor bore.

15. The venturi insert of claim 14, wherein the upstream leading edge is shaped so as to cause substantially all points on the upstream edge to be equidistant from an adjacent point on an adjacent carburetor throttle plate.

16. The venturi insert of claim 15, wherein the venturi insert is slidably placed within the carburetor bore and secured by means of at least one of the following: (a) an interference fit, (b) an adhesive, and (c) a fastener.

17. The venturi insert of claim 16, further comprising a plurality of aerodynamic pieces, wherein each piece is located adjacent to the curved body, each aerodynamic piece residing in a spaced apart relationship from each adjacent aerodynamic piece.

18. A method of improving fuel atomization in a carburetor, comprising the steps of:
forming a ramp within a carburetor bore downstream of a carburetor throttle plate;
enclosing the ramp with an aerodynamic piece; and
isolating airflow downstream of the carburetor throttle plate from regions of the carburetor bore not occupied by the ramp.

19. The method of claim 18, further comprising the steps of:
intercepting liquid fuel entering the carburetor bore; and
directing the liquid fuel along the ramp until the fuel is atomized.

20. The method of claim 19, further comprising the step of affixing a plurality of aerodynamic pieces in a spaced apart relationship above the ramp so as to direct airflow along the ramp.
